(19) United States
(12) Patent Application Publication
(10) Pub. No.: US 2014/0268703 A1
(43) Pub. Date: Sep. 18, 2014

(54) PORTABLE FLASHLIGHT INCLUDING LASER AND LIGHT-EMITTING DIODE (LED) COMBINATION

(71) Applicants: Thomas M. Ehlert, Sacramento, CA (US); Robert J. Shunkwiler, Centerville, UT (US); Wallace G. Tring, Woodland Park, CO (US)

(72) Inventors: Thomas M. Ehlert, Sacramento, CA (US); Robert J. Shunkwiler, Centerville, UT (US); Wallace G. Tring, Woodland Park, CO (US)

(21) Appl. No.: 14/214,383

(22) Filed: Mar. 14, 2014

Related U.S. Application Data
(60) Provisional application No. 61/799,830, filed on Mar. 15, 2013.

(51) Int. Cl. F21L 4/02; F21L 4/00

(52) U.S. Cl. CPC F21L 4/02; F21L 4/00
USPC 362/184; 362/208

(57) ABSTRACT

A portable lighting assembly, such as a flashlight, is disclosed. The portable lighting assembly may include a plurality of light-emitting diodes (LEDs) and a laser controllable by a switch. In some examples, the LEDs are of different colors and the laser is green. The portable lighting assembly may include a lens shield to direct light emissions when in an extended position and not direct light emissions when in a retracted position. The portable lighting assembly may also include a plurality of collimators disposed above the LEDs and a lens disposed above the plurality of collimators and the laser and through which the LEDs and the laser project light.

### CROSS-REFERENCES TO RELATED APPLICATIONS

The present application claims the benefit of U.S. Provisional Application No. 61/799,830 filed on Mar. 15, 2013 the full disclosure of which is incorporated herein by reference.

### BACKGROUND

First responders, including firefighters, police officers, and paramedics and military personnel are often asked to perform their responsibilities under the harshest of conditions. For example, regardless of weather conditions, time of day, or unpredictable dangers, society relies on first responders to respond when called and military personnel to protect sovereign interests. To be prepared for the perils that may accompany the fulfillment of their responsibilities, these individuals often wear specialized gear and carry tools. One such tool may be a battery-operated flashlight. For a police officer, a particular flashlight may be relevant to assisting in a night time arrest. Similarly, a different flashlight or a flare may be used by the officer to alert oncoming traffic of an accident or a stalled vehicle ahead. A firefighter may select a different flashlight while assessing the exterior of a structure than when inside the structure where smoke penetration is more of an issue. In fact, selecting a flashlight that operates adequately in smoky conditions may prove difficult for firefighters and other such individuals. In addition, in some cases, first responders and military personnel are left to use whichever flashlight is available because the cost of purchasing a variety of flashlights may be prohibitive and the difficulty in carrying a variety of flashlights may be cumbersome. Similarly, other users of flashlights (e.g., home users, campers, scouts, etc.) may face the same challenges.

### BRIEF SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

In accordance with at least one embodiment, a portable lighting assembly may include a laser, a light-emitting diode disposed adjacent the laser, and a lens shield configured to slide from a first position to a second position relative to the laser and the light-emitting diode, the lens shield, when in the first position, at least directing light from the light-emitting diode in a forward direction and the lens shield, when in the second position, facilitating the light from the light-emitting diode to project in more than the forward direction.

In some embodiments, the lens shield may include a hollow cylinder surrounding at least a portion of the portable lighting assembly when in both the first position and the second position and the lens shield may be configured to slide along a slide axis substantially parallel to a laser axis according to which the laser projects a laser light in the forward direction.

In some embodiments, the lens may have a generally cylindrical shape and may be disposed above the laser and the light-emitting diode, the lens may also be configured to blend the light emitted by the light-emitting diode and to direct at least a portion of the light emitted by the light-emitting diode in a direction substantially perpendicular to the laser axis.

In some embodiments, the light-emitting diode may be one light-emitting diode in an array of light-emitting diodes and the array of light-emitting diodes may be configured to surround the laser.

In some embodiments, a switch may be in electric communication with the laser and individual light-emitting diodes of the array of light-emitting diodes. The switch may have a plurality of positions with individual positions of the plurality of positions corresponding to the operation of the laser and the individual light-emitting diodes of the array.

In some embodiments, the last may be a green laser and the light-emitting diode may be a green light-emitting diode or a white light-emitting diode.

In some embodiments, the identifier may be at least one of a radio-frequency identification tag or a chip configured to communicate with a global positioning system.

In some embodiments, a compartment may be provided for to receive one or more battery cells. The one or more battery cells, when held in the compartment, may be in electric communication with the light-emitting diode via a printed circuit board.

In accordance with at least one embodiment, a portable lighting assembly may include a laser, a first light-emitting diode disposed above the laser, a second light-emitting diode disposed below the laser, and a switch in electric communication with the laser, the first light-emitting diode and the second light emitting diode. The switch may have a plurality of positions, with individual positions of the plurality of positions corresponding to the operation of the laser, the first light-emitting diode, and the second light-emitting diode.

In some embodiments, the first light-emitting diode may be white light-emitting diode and the second light-emitting diode may be a green light-emitting diode. Selection of individual positions of the switch may cause at least one of the following operations with respect to the laser, the white light-emitting diode, and the green light-emitting diode: power off to the laser, the white light-emitting diode, and the green light-emitting diode; power on to the laser and the white light-emitting diode, and power off to the green light-emitting diode; power on to the laser and the green light-emitting diode, and power off to the white light-emitting diode; power on to the laser, the white light-emitting diode, and the green light-emitting diode; or power on to the laser, and power on to the white light-emitting diode and the green light-emitting diode in a pulsating pattern.

In some embodiments, a lens may be provided for which may be configured to slide from a first position to a second position relative to the laser and the first light-emitting diode. The lens shield, when in the first position, may at least direct light from the first light-emitting diode in a forward direction and, when in the second position, may facilitate the light from the first light-emitting diode to project in more than the forward direction.

In some embodiments, the lens may have a generally cylindrical shape and may be disposed above the laser and the first light-emitting diode. The lens may also be configured to blend light emitted by the first light-emitting diode and to direct at least a portion of the light emitted by the first light-emitting diode in a direction substantially perpendicular to a laser light emitted by the laser.

In some embodiments, the portable lighting assembly may include an array of light-emitting diodes surrounding the laser, the first light-emitting diode and the second light-emitting diode may be included in the array of light-emitting diodes.

In some embodiments, the portable lighting assembly may include an identifier. The identifier may be at least one of a radio-frequency identification tag or a chip configured to communicate with a global positioning system. The identifier may be disposed at or near a distal end of the portable lighting assembly.

In accordance with at least one embodiment, a portable flashlight may include a laser, a light-emitting diode disposed adjacent the laser, a collimator disposed above the light-emitting diode, and a lens having a generally cylindrical shape and disposed above the collimator and the laser. The lens may be configured to blend light emitted by the light-emitting diode and to also direct at least a portion of the light emitted by the light-emitting diode in a direction substantially perpendicular to a laser light emitted by the laser.

In some embodiments, the portable flashlight may include a lens shield configured to slide from a first position to a second position relative to the laser and the light-emitting diode, the lens shield, when in the first position, at least directing light from the light-emitting diode in a forward direction and the lens shield, when in the second position, facilitating the light from the light-emitting diode to project in more than the forward direction.

In some embodiments, the portable flashlight may include a switch in electric communication with the laser and the light-emitting diode, the switch may have a plurality of positions. In some examples, individual positions of the plurality of positions corresponding to the operation of the laser and the light-emitting diode.

In some embodiments, the light-emitting diode may be one light-emitting diode in an array of light-emitting diodes, the array of light-emitting diodes may be disposed circularly around the laser.

In some embodiments, the laser may be a green laser and the array of light-emitting diodes may include at least one of a green light-emitting diode, a white light-emitting diode, a blue light-emitting diode, or a red light-emitting.

In some embodiments, a portable flashlight may include an elongated body having a compartment which may be configured to receive one or more battery cells, and a lighting assembly which may include at least the laser and the light-emitting diode, the lighting assembly may be configured to project the light and a laser light in a direction between 0 and 180 degrees from an axis running parallel to the elongated body.

For a fuller understanding of the nature and advantages of the present invention, reference should be made to the ensuing detailed description and accompanying drawings.

### BRIEF DESCRIPTION OF THE DRAWINGS

Various embodiments in accordance with the present disclosure will be described with reference to the drawings, in which:

FIG. 1A illustrates a forward perspective view of a portable lighting assembly as described herein with a lens shield in a retracted position, according to at least one example;

FIG. 1B illustrates a forward perspective view of the portable lighting assembly as described herein with the lens shield in an extended position, according to at least one example;

FIG. 2 illustrates an exploded perspective view of the portable lighting assembly as described herein, according to at least one example;

FIG. 3A illustrates a forward perspective view of a lighting device of the portable lighting assembly as described herein, according to at least one example;

FIG. 3B illustrates a side view of the lighting device of the portable lighting assembly as described herein, according to at least one example;

FIG. 4 illustrates a forward perspective view of the portable lighting assembly as described herein, according to at least one example; and

FIG. 5 illustrates an electrical schematic for the lighting device of the portable lighting assembly as described herein, according to at least one example.

### DETAILED DESCRIPTION

In the following description, various embodiments of the present invention will be described. For purposes of explanation, specific configurations and details are set forth in order to provide a thorough understanding of the embodiments. However, it will also be apparent to one skilled in the art that the present invention may be practiced without the specific details. Furthermore, well-known features may be omitted or simplified in order not to obscure the embodiment being described.

Embodiments of the present disclosure are directed to, among other things, a portable lighting assembly including at least one light-emitting diode (LED) or other light-emitting device disposed adjacent a laser. In this manner, the light-emitting diode and the laser each project their respective light in roughly the same direction. In some examples, the LED and the laser are configured to project their light through a blending lens. The blending lens may protrude away from the front of the portable lighting assembly in a manner that may allow a portion of light to be reflected in a direction towards the portable lighting assembly. The portable light assembly may also include a lens shield that is movably slide-able along an axis in the same direction (and opposite direction) that the laser and the LED project their respective light. In this manner, the lens shield may direct the light in a forward direction when in an extended position (i.e., beyond the laser or LED), and facilitate light from the LED to project similar to a lantern when in a retracted position. In some examples, the portable lighting assembly may include a multi-position switch that is configured or configurable to turn on and off different combinations of the LED and the laser and to turn on and turn off different strobe patterns with respect to the LED and the laser.

In some embodiments, the portable lighting assembly is a flashlight. By flashlight, we mean a hand-held portable electric-powered light source. Usually the light source is a small incandescent light bulb or (LED). A typical flashlight consists of a light bulb mounted in a reflector, a transparent cover (sometimes combined with a lens) to protect the light source and reflector, a battery, and a switch. These are supported and protected by a case or housing. The housing is typically configured as a cylinder or some other shape that fits the hand of a user.

Features herein can also be implemented in other portable and/or battery operated lights, such as, for example, headlamps, spotlights, lanterns, headlamps, and the like. Particular embodiments are directed to self-contained lighting assemblies that do not need external sources of power so that the lighting assemblies are usable while being transported.

Referring now to the drawings, in which like reference numerals represent like parts throughout the several views, FIG. 1A shows a portable lighting assembly 10 according to at least one embodiment. The portable lighting assembly 10 includes body 12 and lens shield 14. In some examples, the body 12 has an elongated portion extended between a ninety degree bend and/or 180 degree and end cap assembly 24. This elongated portion may include a compartment for receiving one or more battery cells. As would be understood by a person of ordinary skill in the art, the one or more batteries may be any suitable batteries; including, for example, primary cells (i.e., non-rechargeable batteries), secondary cells (i.e., rechargeable batteries), and the like. In some examples, the one or more batteries may be held within separate compartment(s) within the compartment within the body 12. In some examples (as shown in FIG. 1A), the body 12 extends from the ninety degree bend to a lighting assembly 16. In this manner the portable lighting assembly 10 is configured to project light in a direction ninety degrees from the elongated portion of the body 12.

Turning next to the lens shield 14, the lens shield 14 may be slide-able and movable in the direction of arrow 20 and in a direction opposite of the arrow 20 (as shown in more detail in FIG. 1B). In FIG. 1A, the lens shield 14 is shown in a retracted position. In the retracted position, the lens shield 14 does not affect the light that is projected from the lighting assembly 16. Thus, in some examples, the light may project forward away from the lighting assembly 16 in at least 180 degrees as indicated by dashed lines 22. When the lens shield 14 is in the retracted position, the portable lighting assembly 10 can act more like a torch or beacon by providing light to a broad area as the light projects through lens 30. In other words, the portable lighting assembly 10 may also perform the duties of a high-powered beacon that could be easily perceived in environments of limited or non-existent visibility because the light would flow through the front of the lens 30 and the circular sides. This would benefit the victims who may be lost or stranded inside of a burning house, as well as serve the rescue team as to the location of exits and the coordinates of their partners. Because existing beacon lights may be complex and extremely expensive, the portable lighting assembly 10 may be adapted as a conversion kit that would allow conventional flashlights to be easily converted into flashlights including the benefits discussed herein of the portable lighting assembly 10. This may be accomplished by inserting the conversion kit directly into a housing of a conventional flashlight. In some examples.

The portable lighting assembly 10 may also include a switch 18. In some examples, the switch 18 is a multi-position switch that controls the operation of a laser 28 and a plurality of LED assemblies (i.e., 26(1)-26(4)) of the lighting assembly 16. In an example embodiment, the laser 28 may be a green laser, the LED assemblies 26(1) and 26(4) are green LEDs, and the LED assemblies 26(2) and 26(3) are white LEDs. Continuing with this example, the switch 18 may be configured to have five positions and each position may correspond to an operation of the laser 28 and the LED assemblies 26(1)-26(4). For example, in a first position the laser 28 and the LEDs 26(1)-26(4) are off; in a second position, the laser 28 is off and the white LEDs (i.e., 26(2) and 26(3)) are both on and the green LEDs (i.e., 26(1) and 26(4)) are both off; in a third position the laser 28 is on and the white LEDs (i.e., 26(2) and 26(3)) are both off and the green LEDs (i.e., 26(1) and 26(4)) are both on; in a fourth position, the laser 28 is on and the white LEDs (i.e., 26(2) and 26(3)) and the green LEDs (i.e., 26(1) and 26(4)) are on; and, in a fifth position, the laser 28 is on and the white LEDs (i.e., 26(2) and 26(3)) and the green LEDs (i.e., 26(1) and 26(4)) are illuminated in a pulsating or strobe pattern. The control of the LED assemblies 26(1)-26(4) and, in some cases, the laser 28 may be provided for by a printed circuit board. In some examples, the laser 28 may be configured to pulse and/or strobe. In accordance with at least one embodiment, the power to the laser 28 may remain on while power to the green, white, or other colored LED assemblies 26(1)-26(4) is on.

In some examples, the laser 28 may be a laser diode of any suitable color other than green (e.g., red, red-orange, yellow, blue, or violet). Depending on the wavelength and semiconductor materials used for construction, the LED assemblies 26(1)-26(4) may also include any suitable colors other than green and white (e.g., infrared, red, orange, yellow, blue, violet, purple, ultraviolet, or pink). The color of the laser 28 and the LED assemblies 26(1)-26(4) may be selected as suitable for a particular implementation. It is noted, however, that a green laser in connection with green and white LEDs has been proven effective.

Turning next to FIG. 1B in which the portable lighting assembly 10 is shown with the lens shield 14 in an extended position. In this example, the lens shield 14 has been slide-ably moved away from the body 12 such that the lighting assembly 16, including the lens 30, is within the lens shield 14. When in the extended position, the lens shield 14 may direct the light from the lighting assembly 16 in more of a focused direction than when in the retracted position (as shown in FIG. 1A). Moreover, the volume of light from the lighting assembly 16 (i.e., the combination of the plurality of LED assemblies 26(1)-26 and the laser 28) may be so intense (e.g., to penetrate smoke, light up a dark room, penetrate window tinting, etc.) that a shield may be desirable to limit eye fatigue of the user. Therefore, the lens shield 14 may be moveably slide-able to not only adjust the direction of the light, but to also limit eye fatigue of the user. The forward or extended position of the light shield also may serve to protect the lighting assembly 16, including the lens 30. For example, in some embodiments, the body 12 and/or the lens shield 14 may be constructed of a high tensile strength material capable of withstanding extreme conditions, such as being run over by heavy vehicles. In some examples, the body 12 and the lens shield 14 and other components of the portable lighting assembly 10 may be constructed of any suitable material including, for example, plastics (including high density plastic), metals, carbon fibers, and the like. In some examples, the lens shield 14 is hollow.

Turning next to FIG. 2 in which the portable lighting assembly 10 is illustrated in an exploded view according to an example embodiment, the body 12 may include body connection point 42 to connect the body 12 to the lighting assembly 16. In this example, the body connection point 42 is illustrated as a threaded collar. In some examples, the body connection point 42 constructed in any suitable manner to connect the body 12 and the lighting assembly 16. The lighting assembly 16 may include a first bell housing 44, the lighting device 62, a second bell housing 52, a lens 30, and a lens cap 56. The first bell housing 44 and the second bell housing 52 may be screwed together to retain other components of the lighting assembly 16 (e.g., the lighting device 62). In some examples, the connections between the first bell housing 44 and the second bell housing 52 include any suitable connection mechanism including, for example, a snap fit, an interference fit, a turn-and-lock connection, and the like. The lens cap 56 may be configured to retain the lens 30. Thus, the lens cap 56 may include a raised lip on its interior surface that corresponds to a raised lip on the bottom edge of the lens 30 such that the two lips correspond to each other when the lens cap 56 is attached to the second bell housing 52. As illustrated in FIG. 2, the lens 30 may protrude beyond the lens cap 56. In this manner, the lens 30 may direct light forward, through the sides of the lens 30, and in a direction opposite the forward direction.

The lighting device 62 may be disposed somewhere within the first bell housing 44, the second bell housing 52, and the body 12 such that these other components provide protection to the lighting device 62. This may be desirable because, as discussed in more detail below, the components of the lighting device 62 may be more fragile than the bell housings 44 and 52 and may be more constructed of a lower tensile material. The lighting device 62 may include a lighting housing 46, a printed circuit board (PCB) 48, the laser 28, and the LED assemblies 26(1)-26(4). The lighting housing 46 may be constructed of a rigid or semi-rigid material. In some examples, the lighting housing 46 may provide protection to the laser 28 and parts of the LED assemblies 26(1)-26(4). For example, while a forward portion of the laser 28 is shown extending from the surface of the lighting housing 46, a rearward portion (not shown) of the laser 28 extends within the lighting housing 46. In some examples, the entirety of the laser 28 may be located within the lighting housing 46. The PCB 48 may be mounted and/or attached to the lighting housing 46. In some examples, the PCB 48 may enable operation of the LED assemblies 26(1)-26(4) and, in some cases, the operation of the laser 28, other LEDs, and other lasers. The PCB 48 may be any suitable PCB capable of controlling the operation of the lighting components of the lighting device 62. The lighting device 62 may be in electrical communication with the switch 18 and one or more battery cells within battery cavity 40 via wiring 50. The wiring 50 may include any suitable wiring.

Turning next to the description of the end cap assembly 24 as illustrated in FIG. 2. The end cap assembly 24 may include body threads 34, end cap 36, and an identifier 38. In some examples, the body threads 34 correspond to threads within the end cap 36. In this manner, the tight seal may be achieved between the battery cavity 40 and the end cap 36. The identifier 38 may be retained within the end cap 36. In some examples, the identifier 38 may be an active identifier, a passive identifier, or otherwise. For example, the identifier 38 may be a passive, radio-frequency identification (RFID) tag readable via electromagnetic induction or an active RFID tag that periodically transmits its identification signal and pulls voltage from a battery cell, or a battery-assisted RFID tag that transmits when activated by a reader and pulls voltage when activated. In accordance with at least one embodiment, the identifier 38 may be a chip configured to communicate with a global positioning system (GPS). Thus, in some examples, the identifier 38 may in electric communication with one or more battery cells within the battery cavity 40 and/or auxiliary or dedicated battery cells. The identifier 38, in some examples, may include human-readable representation of data (e.g., text and numbers) and/or machine readable (e.g., bar codes, quick response codes (QR codes), etc.) representations of data. In this manner, the identifier 38 may be used to provide information about the portable lighting assembly 10. The identifier 38 may also be retained within the battery cavity 40 and, in some examples, may be disposed adjacent to or within other portions of the body 12 and/or the lens shield 14. In accordance with at least one embodiment, the identifier 38 may include more than one identifier. The battery cavity 40 may be configured to receive one or more battery cells as discussed previously. In addition, in some examples, the battery cavity 40 may be configured to receive the identifier 38.

Turning next to FIG. 3A and FIG. 3B in which the lighting device 62 is shown in greater detail. As discussed previously, the lighting device 62 may include the lighting housing 46, the PCB 48, the laser 28, and the LED assemblies 26(1)-26(4). In FIG. 3A and FIG. 3B, the LED assemblies 26(1)-26(4) are shown in greater detail. For example, the LED assembly 26(3) may include LED 58(3) and collimator 60(3). Corresponding pairs of LEDs and collimators are also illustrated for LED assemblies 26(1), 26(2), and 26(3). In accordance with at least one embodiment, the lighting device 62 may include the laser 28 and one LED assembly (e.g., the LED assembly 26(3)). In some examples, the LED assemblies 26(1)-26(4) may be disposed in a circular array around the laser 28. Thus, in some examples, the laser 28 may be placed at the center of a circle and any suitable number of LED assemblies (i.e., more than one) may be arranged on along the circumference of the circle.

Such a configuration of the LED assemblies 26(1)-26(4) and the laser 28 may desirable in smoky conditions. For example, conventional flashlight models reflect emitted light back when they are directed toward smoke. This smoke and other pollutants that may be present in the air reduce the strength of the produced light, which may prevent a firefighter from seeing a victim only a few feet away from them. Thus, not only may the firefighter have a difficult time locating a victim, he or she may also have limited visibility of the position of their partners, any likely exists, and possible dangerous areas such as missing stairs and holes in the floor. In addition, because the portable lighting assembly 10 may combine both the LED assemblies 26(1)-26(4) and the laser 28 to produce an amplified light source capable of penetrating smoke, smog, fog, or dust.

In some examples, the LED assemblies 26(1)-26(4) may provide broad view illumination while the laser 28 may serve as a range identifier. In other words, the LED assemblies 26(1)-26(4) may project light on an obstacle and the laser 28 (by considering the length of the laser light or beam) may help a user to determine how close he or she is to the obstacle. Additionally, the laser 28 may serve a more conventional purpose as a pointer. In some examples, the laser 28 may be used to point out areas of concern (i.e., where a fellow firefighter should cut into a roof or door, where a person was last seen, etc.). In some examples, the combination of the laser 28 and the LED assemblies 26(1)-26(4) may provide enhanced illumination into glass windows that have been tinted. In this manner, the portable lighting assembly 10 may be utilized by police officers in making traffic stops.

As illustrated in FIG. 3A and FIG. 3B, collimator 60(1) may be disposed directly above LED 58(1). Such an arrangement may be desirable to focus the light projecting from the LED 58(1). Each LED, such as the LED 58(1) may be attached or retained within the PCB 48. Thus, in some examples, the PCB 48 may maintain the wiring and electronics to enable operation and control of the operation and color of the LEDs. The lens 30 may be placed directly above the collimators, such as the collimator 60(1). The lens 30 may be selected to amplify the light source from the laser 28 and the LED assemblies 26(1)-26(4). This amplification may result in an increase in the volume of light and may also contribute to the projection of the light in a 360 degree circumference and in a 180 degree arc. In some examples, the lens 30 may project light beyond 180 degrees. For example, projection up to 270 degrees has been demonstrated using the lens 30. Thus, the lens 30 may be configured to direct light in a forward direction (away from the laser 28) and to also diffuse and/or refract light in 360 degrees at least perpendicular to the forward direction, and in some examples, beyond perpendicular (i.e., 40 degrees beyond perpendicular). Thus, in some examples, the lens 30 may operate like unto a torch by projecting light at least 180 degrees horizontally and 360 degrees around a laser light beam.

Turning next to FIG. 4 in which the portable lighting assembly 10 is shown in accordance with at least one example embodiment. The portable lighting assembly 10 may be configured such that an axis running lengthwise through the body 12 and an axis running lengthwise through the lens shield 14 are substantially parallel. In accordance with this configuration, the portable lighting assembly 10 may be placed on surface 66 (e.g., a roadway, runway, etc.) and, when the lens shield 14 is in the retracted position, the lighting device 62 may project light similar to a flare (i.e., 180 degrees horizontally and 360 degrees around a laser light beam). Thus, the projected light may extend at least along dashed lines 64. In some examples, the projected light may extend below the dashed lines 64 and above the dashed lines 64.

The portable lighting assembly 10 may be scalable such that its features can be implemented in larger and/or smaller lighting devices. For example, in an up-scaled/heavy mounted embodiment, the portable lighting assembly 10 may be used to provide illumination capabilities on vehicles, vessels, and aircraft. In this embodiment, the portable lighting assembly 10 may be fixed or secured to the vehicle, the vessel, or the aircraft and be hard-wired to the power system of the vehicle, the vessel, or the aircraft.

In some examples, the portable lighting assembly 10 may be a 90-degree flashlight, such as the embodiments described with reference to FIGS. 1A-2. Such 90-degree flashlights are often used by first responders and may provide handheld mobility and may also include functionality to enable the portable lighting assembly 10 to clip directly onto a first responder's suit. In some examples, the portable lighting assembly 10 when a 90-degree flashlight may be designed having dimensions similar to conventional firefighting flashlights (e.g., one being tall and thin and the other being stocky and compact). Such dimensions may be desirable to ensure that firefighters and other first responders could easily adopt the design and easily transport or carry the portable lighting assembly 10.

The portable lighting assembly 10 may also include a clip affixed behind the lighting assembly 16. Using the clip*, a user could easily store the portable lighting assembly when the user is not using it. As discussed previously, the switch 18 may be a toggle switch located on the outside surface of the body 12 such that a user could turn it on or off while it is still clipped to his or her belt or pocket.

In accordance with at least one embodiment, a lantern or box version of the portable lighting assembly 10 may be provided for. Such an embodiment may be powered by one or more rechargeable battery cells. It may also include a rubberized handle affixed to a top portion of the body 12 for carrying convenience. In accordance with this embodiment, the portable lighting assembly 10 may measure approximately 6.25″ in length and 6.75″ in height, from the handle to the bottom of the portable lighting assembly 10. In some examples, a charging system may also be provided for capable of supporting alternating current (AC) and/or direct current (DC) charging capabilities.

Turning finally to FIG. 5 in which an example electrical diagram 68 is presented. The electrical diagram 68 may include one or more LED endpoints (e.g., 70-76) and one or more resistors (78-82). The resistor 78 may be included to provide white light, the resistor 80 may be included to provide green light, and the resistor 82 may be included to provide strobe and/or pulsating lighting patterns.

Other variations are within the spirit of the present invention. Thus, while the invention is susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

What is claimed is:

1. A portable lighting assembly comprising:
a laser;
a light-emitting diode disposed adjacent the laser; and
a lens shield configured to slide from a first position to a second position relative to the laser and the light-emitting diode, the lens shield, when in the first position, at least directing light from the light-emitting diode in a forward direction and the lens shield, when in the second position, facilitating the light from the light-emitting diode to project in more than the forward direction.

2. The portable lighting assembly of claim 1, wherein the lens shield comprises a hollow cylinder surrounding at least a portion of the portable lighting assembly when in both the first position and the second position and wherein the lens shield is configured to slide along a slide axis, the slide axis substantially parallel to a laser axis according to which the laser projects a laser light in the forward direction.

3. The portable lighting assembly of claim 1, further comprising a lens having a generally cylindrical shape and disposed above the laser and the light-emitting diode, the lens configured to blend the light emitted by the light-emitting diode and to direct at least a portion of the light emitted by the light-emitting diode in a direction substantially perpendicular to the laser axis.

4. The portable lighting assembly of claim 1, wherein the light-emitting diode is one light-emitting diode in an array of light-emitting diodes, the array of light-emitting diodes surrounding the laser.

5. The portable lighting assembly of claim 4, further comprising a switch in electric communication with the laser and individual light-emitting diodes of the array of light-emitting diodes, the switch having a plurality of positions, individual positions of the plurality of positions corresponding to the operation of the laser and the individual light-emitting diodes of the array.

6. The portable lighting assembly of claim 1, wherein the laser comprises a green laser and the light-emitting diode comprises at least one of a green light-emitting diode or a white light-emitting diode.

7. The portable lighting assembly of claim 1, further comprising an identifier, the identifier comprising at least one of a radio-frequency identification tag or a chip configured to communicate with a global positioning system.

8. The portable lighting assembly of claim 1, further comprising a compartment configured to received one or more battery cells, the one or more battery cells when held in the compartment being in electric communication with the light-emitting diode via a printed circuit board.

9. A portable lighting assembly comprising:
a laser;
a first light-emitting diode disposed above the laser and a second light-emitting diode disposed below the laser; and
a switch in electric communication with the laser, the first light-emitting diode and the second light emitting diode, the switch having a plurality of positions, individual positions of the plurality of positions corresponding to the operation of the laser, the first light-emitting diode, and the second light-emitting diode.

10. The portable lighting assembly of claim 9, wherein the first light-emitting diode comprises a white light-emitting diode and the second light-emitting diode comprises a green light-emitting diode and selection of individual positions of the switch causes at least one of the following operations with respect to the laser, the white light-emitting diode, and the green light-emitting diode:
power off to the laser, the white light-emitting diode, and the green light-emitting diode;
power off to the laser and the green light-emitting diode, and power on to the white light-emitting diode;
power on to the laser and the green light-emitting diode, and power off to the white light-emitting diode;
power on to the laser, the white light-emitting diode, and the green light-emitting diode; or
power on to the laser, and power on to the white light-emitting diode and the green light-emitting diode in a pulsating pattern.

11. The portable lighting assembly of claim 9, further comprising a lens shield configured to slide from a first position to a second position relative to the laser and the first light-emitting diode, the lens shield, when in the first position, at least directing light from the first light-emitting diode in a forward direction and the lens shield, when in the second position, facilitating the light from the first light-emitting diode to project in more than the forward direction.

12. The portable lighting assembly of claim 9, further comprising a lens having a generally cylindrical shape and disposed above the laser and the first light-emitting diode, the lens configured to blend light emitted by the first light-emitting diode and to direct at least a portion of the light emitted by the first light-emitting diode in a direction substantially perpendicular to a laser light emitted by the laser.

13. The portable lighting assembly of claim 9, further comprising an array of light-emitting diodes surrounding the laser, the first light-emitting diode and the second light-emitting diode included in the array of light-emitting diodes.

14. The portable lighting assembly of claim 9, further comprising an identifier, the identifier comprising at least one of a radio-frequency identification tag or a chip configured to communicate with a global positioning system, the identifier disposed at or near a distal end of the portable lighting assembly.

15. A portable flashlight comprising:
a laser;
a light-emitting diode disposed adjacent the laser;
a collimator disposed above the light-emitting diode; and
a lens having a generally cylindrical shape and disposed above the collimator and the laser, the lens configured to blend light emitted by the light-emitting diode and to direct at least a portion of the light emitted by the light-emitting diode in a direction substantially perpendicular to a laser light emitted by the laser.

16. The portable flashlight of claim 15, further comprising a lens shield configured to slide from a first position to a second position relative to the laser and the light-emitting diode, the lens shield, when in the first position, at least directing light from the light-emitting diode in a forward direction and the lens shield, when in the second position, facilitating the light from the light-emitting diode to project in more than the forward direction.

17. The portable flashlight of claim 15, further comprising a switch in electric communication with the laser and the light-emitting diode, the switch having a plurality of positions, individual positions of the plurality of positions corresponding to the operation of the laser and the light-emitting diode.

18. The portable flashlight of claim 15, wherein the light-emitting diode is one light-emitting diode in an array of light-emitting diodes, the array of light-emitting diodes disposed circularly around the laser.

19. The portable flashlight of claim 18, wherein the laser comprises a green laser and the array of light-emitting diodes comprises at least one of a green light-emitting diode, a white light-emitting diode, a blue light-emitting diode, or a red light-emitting.

20. The portable flashlight of claim 15, further comprising:
an elongated body having a compartment configured to receive one or more battery cells; and
a lighting assembly including at least the laser and the light-emitting diode, the lighting assembly configured to project the light and a laser light in a direction between 0 and 180 degrees from an axis running parallel to the elongated body.
